(19) United States
(12) Patent Application Publication
(10) Pub. No.: US 2004/0239512 A1
(43) Pub. Date: Dec. 2, 2004

(54) Lightning protection for a network element

(75) Inventors: Charles Weston Lomax JR., Raleigh, NC (US); Clark Wayne Tollerson, Raleigh, NC (US); Melvin Richard Phillips, Youngsville, NC (US)

Correspondence Address: FOGG AND ASSOCIATES, LLC, P.O. BOX 581339, MINNEAPOLIS, MN, 55458-1339, US

(73) Assignee: ADC DSL SYSTEMS, INC.

(21) Appl. No.: 10/448,884

(22) Filed: May 30, 2003

(51) Int. Cl. G08B 21/00

(52) U.S. Cl. 340/638; 361/111; 713/300

(57) ABSTRACT

A method of responding to an overload condition includes supplying power on a communication medium in order to provide power to a network element coupled to the communication medium. The method further includes determining if an overload condition exists. If the overload condition exists, the supply of power on the communication medium is stopped for a predetermined period of time. After the predetermined period of time has elapsed, resuming supplying power on the communication medium. If the overload condition still exists after resuming supplying power on the communication medium, signaling a first alarm and/or shutting down a power supply used to supply power on the communication medium.

### CROSS REFERENCE TO RELATED APPLICATIONS

This application is related to co-pending application Ser. No. 10/134,323, filed on Apr. 29, 2002 and entitled MANAGING POWER IN A LINE POWERED NETWORK ELEMENT (the '323 application). The '323 application is incorporated herein by reference.

This application is also related to the following applications filed on even date herewith, all of which are hereby incorporated herein by reference:

United States patent application serial no. ______, entitled “FUNCTION FOR CONTROLLING LINE POWERED NETWORK ELEMENT”, Attorney Docket No. 100.358US01 (the '358 application);

U.S. patent application Ser. No. ______, entitled “NETWORK ELEMENT IN A LINE POWERED NETWORK,” Attorney Docket No. 100.359US01 (the '359 application);

U.S. patent application Ser. No. ______, entitled “ELEMENT MANAGEMENT SYSTEM IN A LINE POWERED NETWORK,” Attorney Docket No. 100.360US01 (the '360 application);

U.S. patent application Ser. No. ______, entitled “SPLITTER,” Attorney Docket No. 100.592US01 (the '592 application);

U.S. patent application Ser. No. ______, entitled “CURRENT SENSE CIRCUIT IN A LINE POWERED NETWORK ELEMENT,” Attorney Docket No. 100.589US01 (the '589 application);

U.S. patent application Ser. No. ______, entitled “INPUT VOLTAGE SENSE CIRCUIT IN A LINE POWERED NETWORK ELEMENT,” Attorney Docket No. 100.590US01 (the '590 application);

U.S. patent application Ser. No. ______, entitled “CENTRAL OFFICE POWER PLUG,” Attorney Docket No. 100.592US01 (the '592 application); and

U.S. patent application Ser. No. ______, entitled “POWER RAMP-UP IN A LINE-POWERED NETWORK ELEMENT SYSTEM,” Attorney Docket No. 100.593 (the '593 application).

### TECHNICAL FIELD

The present invention relates generally to the field of telecommunications, and, in particular, to managing line power for network elements in an access network.

### BACKGROUND

Telecommunications networks transport signals between user equipment at diverse locations. A telecommunications network includes a number of components. For example, a telecommunications network typically includes a number of switching elements that provide selective routing of signals between network elements. Additionally, telecommunications networks include communication media, e.g., twisted pair, fiber optic cable, coaxial cable or the like that transport the signals between switches. Further, some telecommunications networks include access networks.

For purposes of this specification, the term access network means a portion of a telecommunication network, e.g., the public switched telephone network (PSTN), that allows subscriber equipment or devices to connect to a core network. For example, an access network is the cable plant and equipment normally located in a central office or outside plant cabinets that directly provides service interface to subscribers in a service area. The access network provides the interface between the subscriber service end points and the communication network that provides the given service. An access network typically includes a number of network elements. A network element is a facility or the equipment in the access network that provides the service interfaces for the provisioned telecommunication services. A network element may be a stand-alone device or may be distributed among a number of devices.

There are a number of conventional forms for access networks. For example, the digital loop carrier is an early form of access network. The conventional digital loop carrier transported signals to and from subscriber equipment using two network elements. At the core network side, a central office terminal is provided. The central office terminal is connected to the remote terminal over a high-speed digital link, e.g., a number of T1 lines or other appropriate high-speed digital transport medium. The remote terminal of the digital loop carrier typically connects to the subscriber over a conventional twisted pair drop.

The remote terminal of a digital loop carrier is often deployed deep in the customer service area. The remote terminal typically has line cards and other electronic circuits that need power to operate properly. In some applications, the remote terminal is powered locally. Unfortunately, to prevent failure of the remote terminal due to loss of local power, a local battery plant is typically used. This adds to the cost and complicates the maintainability of the remote terminal, due to the outside plant operational requirements which stipulate operation over extended temperature ranges.

In some networks, the remote terminal is fed power over a line from the central office. This is referred to as line feeding or line powering and can be accomplished through use of an AC or a DC source. Thus, if local power fails, the remote terminal still functions because it is typically powered over the line using a battery-backed power source. This allows the remote terminal to offer critical functions like lifeline plain old-fashioned telephone service (POTS) even during a power outage.

The device that feeds such line-powered remote terminals (typically a central office terminal), typically includes various protection devices that protects the various components of the central office terminal from electrical surges and other conditions that may occurs on the twisted-pair telephone line that couples the central office terminal to the remote terminal. In one configuration, a first protection device is coupled across the tip line of a twisted-pair telephone line and ground and a second protection device is coupled across the ring line of the twisted-pair telephone line and ground. These protection devices often include sidactors.

When an over voltage condition exists on the tip or ring line (for example, due to lightning), the protection device turns on and shorts the tip or ring line to ground. The protection device stays turned on until voltage across the protection device drops below the turn on voltage and the current conducted by the protection device to ground drops below a specified hold current. Typically, the power supply of the central office terminal will shutdown and stop supplying power on the twisted-pair line when such a current surge event occurs. This causes the voltage across the protection device to drop below the turn on voltage and the current conducted by the protection device to drop below the holding current for the protection device (assuming the source of the surge has been eliminated, which is typically the case with a lightning surge). However, the power supply will typically not start supplying power until the power supply has gone through a complete reboot process. If the time required to reboot the power supply is relatively long, the remote terminal powered by the telephone line can lose power and the high priority telecommunication services such as lifeline POTS that are provided by the remote terminal could be dropped.

### SUMMARY

In one embodiment, a method of responding to an overload condition includes supplying power on a communication medium in order to provide power to a network element coupled to the communication medium. The method further includes determining if an overload condition exists. If the overload condition exists, the supply of power on the communication medium is stopped for a predetermined period of time. After the predetermined period of time has elapsed, supplying power on the communication medium is resumed. If the overload condition still exists after resuming supplying power on the communication medium, a first alarm is signaled.

In another embodiment, a network element includes communication interface that produces a telecommunication service signal that includes traffic for a communication link. The network element further includes a power interface adapted to couple the network element to a power source. The power interface includes a power supply that produces a power signal. The network element further includes a controller that controls the operation of the power supply, and a splitter that combines the telecommunication service signal with the power signal and applies the combined signal to the communication medium. The network element further includes a protection device adapted to be coupled between the communication medium and a ground. The controller causes the power supply to supply power on the communication medium. The controller also determines if an overload condition exists. The controller, if the overload condition exists, causes the power supply to stop supplying power on the communication medium for a predetermined period of time. The controller, after the predetermined period of time has elapsed, causes the power supply to resuming supplying power on the communication medium. The controller, if the overload condition still exists after the power supply resumes supplying power on the communication medium, signals a first alarm.

In another embodiment, a network element includes an interface adapted to couple the network element to a communication medium and a power supply adapted to couple the network element to a power source. The network element also includes a protection device adapted to be coupled between the communication medium and a ground. The power supply supplies power on the communication medium. The network element determines if an overload condition exists. If the overload condition exists, the power supply stops supplying power on the communication medium for a predetermined period of time. After the predetermined period of time has elapsed, the power supply resumes supplying power on the communication medium. If the overload condition still exists after the power supply resumes supplying power on the communication medium, the network element signals a first alarm.

In another embodiment, a network includes a source network element including a power supply coupled to a power source and a sink network element coupled to the source network element over a communication medium. The source network element includes a protection device coupled between the communication medium and a ground. The power supply supplies power on the communication medium. The source network element determines if an overload condition exists. If the overload condition exists, the power supply stops supplying power on the communication medium for a predetermined period of time. After the predetermined period of time has elapsed, the power supply resumes supplying power on the communication medium. If the overload condition still exists after the power supply resumes supplying power on the communication medium, the source network element signals a first alarm.

### BRIEF DESCRIPTION OF THE DRAWINGS

FIG. 1 is block diagram of one embodiment of network that includes at least one line-powered network element.

FIG. 2 is a block diagram of one embodiment of a central office terminal.

FIG. 3 is a block diagram of one embodiment of a wireless network.

FIG. 4 is flow diagram of one embodiment of a method of responding to an overload condition in a network including line-powered network elements.

Like reference numbers and designations in the various drawings indicate like elements.

### DETAILED DESCRIPTION

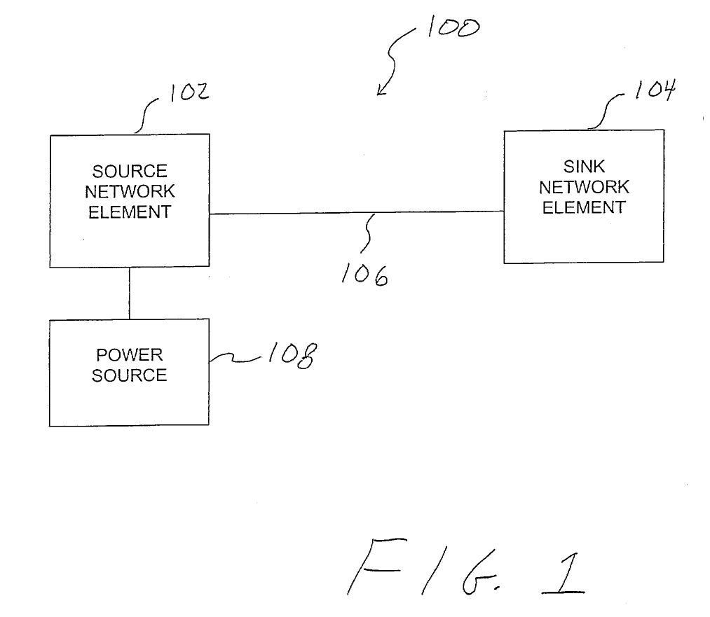

FIG. 1 is block diagram of one embodiment of network 100 that includes at least one line-powered network element. Network 100 includes at least one network element 102 (referred to here as a “source network element”) that provides power to at least one other network element 104 (referred to here as a “sink network element”) over a communication medium 106 (referred to here as a “power communication medium”). In the one embodiment, the source network element 102 is a central office terminal located in central office of a service provider and the sink network element 104 is a remote terminal located in the outside plant, for example, in an environmentally hardened enclosure. In such an embodiment, both the central office terminal 102 and the remote terminal 104 are included in an access network that couples one or more items of customer located equipment (for example, a modem, wireless access point, or telephone set) to a communications network such as the Internet or public switched telephone network (PSTN). The central office terminal provides power to the remote terminal over at least one twisted-pair telephone line. That is, in such embodiment, the twisted-pair telephone line is the power communication medium 106.

The source network element 102 is coupled to a power source 108 in order to obtain power that is used to power the source network element 102 and to provide power to the sink network element 104 over the power communication medium 106. In one embodiment, the power source 108 includes a direct current (DC) and/or an alternating current (AC) power source such as a battery and/or a connection the main power grid. In other embodiments, other powers sources are used.

The source network element 102 and the sink network element 104 communicate with one another using some type of communication link. For example, in one embodiment, a central office terminal and a remote terminal communicate over a DSL communication link provided between the central office terminal and the remote terminal. Examples of DSL communication links includes a high-bit rate DSL (HDSL) link, high-bit rate digital subscriber line 2 (HDSL2) link, high-bit rate digital subscriber line 4 (HDSL4) link, asymmetric digital subscriber line (ADSL) link, or symmetric DSL link conforming to the International Telecommunication Union (ITU) standard G.991.2 (a G.SHDSL link). In other embodiments, other types of communication links are used.

In the embodiment shown in FIG. 1, the communication link is provided on the same communication medium that is used to supply power from the source network element 102 to the source network element 104. In other embodiments, a separate communication medium is used to provide such a communication link between the source network element 102 and the sink network element 104.

Both the source network element 102 and the sink network element 104 are typically coupled to other network elements. For example, in one embodiment, the source network element 102 is coupled to an upstream network element such as a switch and the sink network element 104 is coupled to one or more downstream network elements such as various items of customer located equipment (for example, a modem, wireless access point, or telephone set).

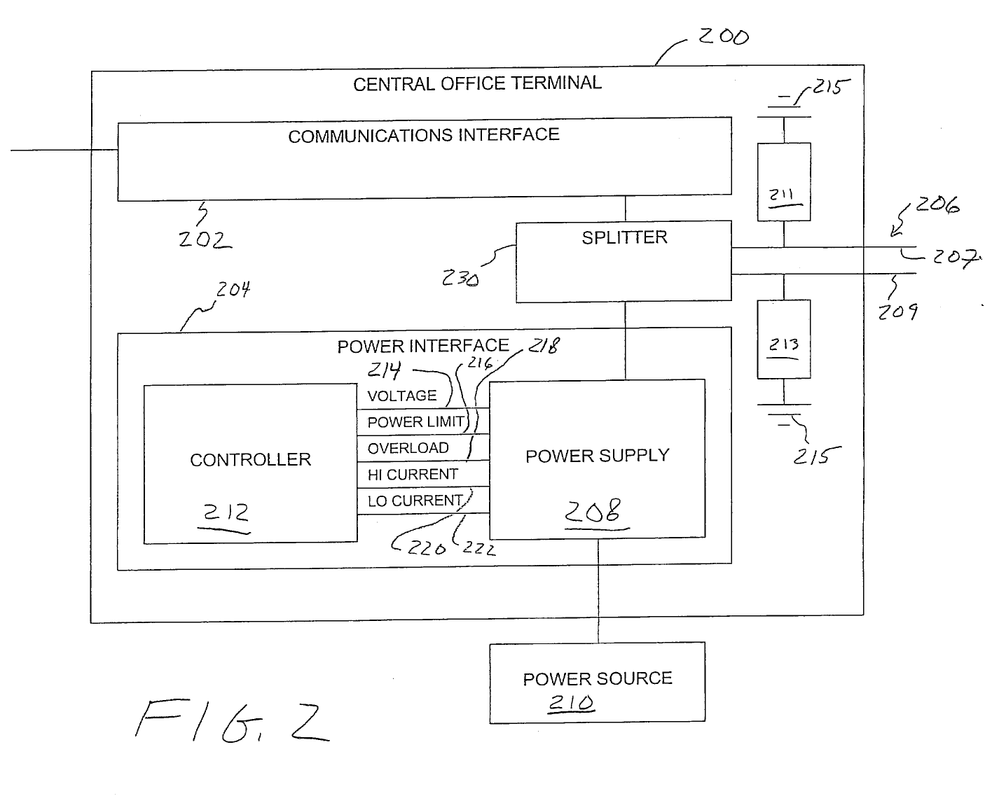

FIG. 2 is a block diagram of one embodiment of a central office terminal 200. Embodiments of central office terminal 200 are suitable for providing power to one or more remote terminals (or other network elements) over one or more twisted-pair telephone lines (or other communication medium). The embodiment of a central office terminal 200 shown in FIG. 2 includes communication interface 202 and a power interface 204. The communication interface 202 includes appropriate components for providing the various telecommunications service provided by the central office terminal 200. For example, in the embodiment shown in FIG. 1, the communications interface 202 couples the central office terminal 200 to at least one upstream G.SHDSL communication link and to at least one downstream G.SHDSL communication link (via a splitter 230 described below). The downstream G.SHDSL communication links is provided over at least one twisted-pair telephone line 206. The twisted-pair telephone line 206 is coupled, in one embodiment to one or more remote terminals (not shown in FIG. 2) that are powered by the central office terminal 200.

In the embodiment shown in FIG. 2, twisted-pair telephone line 206 includes a tip line 207 and a ring line 209. A first protection device 211 is coupled between the tip line 207 and ground 215. A second protection device 213 is coupled between the ring line 208 and ground 215. In one embodiment, the first and second protection devices 211 and 213 are voltage-controlled sidactors. In such an embodiment, when the voltage across the tip line 207 and ground 215 exceeds the turn on voltage for the first protection device 211, the first protection device 211 turns on and shorts the tip line 207 to ground 215 until the voltage across the protection device 211 drops below the turn on voltage and the current conducted by the first protection device 211 drops below the holding current for that protection device 211. Similarly, when the voltage across the ring line 209 and ground 215 exceeds the turn on voltage for the second protection device 213, the second protection device 213 turns on and shorts the ring line 209 to ground 215 until the voltage across the protection device 213 drops below the turn on voltage the current conducted by the second protection device 213 drops below the holding current for that protection device 213.

The power interface 204 includes a power supply 208 that is coupled to a power source 210. In general, the power supply 208 receives power from the power source 210 and conditions and supplies power on the twisted-pair telephone lines 206 in order to power a remote terminal coupled to the twisted-pair telephone line 206. In one such embodiment, the power supply 208 is implemented as a fly-back power supply. The central office terminal 200 includes a splitter 230 that combines an output communication signal from the communications interface 202 and an output power signal from the power interface 204 and applies the combined output signal to the twisted-pair telephone line 206. The splitter 230 also receives an input signal from the twisted-pair telephone line 206 and splits off that portion of the received input signal used for providing the downstream communication link and provides it to the communications interface 202 for appropriate processing. One embodiment of a splitter 230 is described in the '592 application.

The power interface 204 also includes a controller 212 that controls the operation of the power supply 208. In one such embodiment, controller 212 is implemented in hardware (for example, using analog and/or digital circuits) and/or in software (for example, by programming a programmable processor with appropriate instructions to carry out the various control functions described here). In other embodiments, the controller 212 is implemented in other ways. Although the controller 212 is shown as being a part of the power interface 204 in FIG. 2, in other embodiments the controller 212 is a part of a general controller or control circuitry for the central office terminal 200. In other embodiments, the functions performed by the controller 212 are incorporated directly into control circuitry of the power supply 208.

In the embodiment shown in FIG. 2, a voltage signal 214 is provided between the controller 212 and the power supply 208. The voltage signal 214 is used by the controller 212 to set a nominal voltage at which the power supply 208 is to supply power on the twisted-pair telephone line 206 in order to power a remote terminal coupled to the twisted-pair telephone line 206. A power limit signal 216 is provided between the controller 212 and the power supply 208. The power limit signal 216 is used by the controller 212 to set a power limit for the power supply 208. The power limit is a maximum power the power supply 208 is to provide on the twisted-pair telephone line 206.

An overload signal 218 is provided by the power supply 208 to the controller 212. The overload signal 218 is used by the power supply 208 to inform the controller 212 that the power supply 208 is currently supplying power with an output voltage that is below the nominal voltage specified on the voltage signal 214. This is referred to here as an “overload condition” or that the power supply 208 is “out of regulation.” For example, when a remote terminal coupled to the twisted-pair telephone line 206 draws an amount of current that causes the amount of power supplied by the power supply 208 to exceed the power limit specified by the power limit signal 216, the power supply 208 drops the output voltage so that the total power supplied by the power supply 208 does not exceed the power limit. When an overload condition exists, the power supply 208 indicates that such an overload condition exists on the overload signal 218.

In the embodiment shown in FIG. 2, various current measurement signals are supplied by the power supply 208 to the controller 212. For example, a low current signal 220 is supplied by the power supply 208 to the controller 212 to indicate that the current currently supplied by the power supply 208 is below some relatively low threshold current value. A high current signal 222 is supplied by the power supply 208 to controller 212 to indicate that the current currently supplied by the power supply 208 is above some relatively high current value. In other embodiments, the amount of current currently supplied by the power supply 208 is measured and provided to the controller 212.

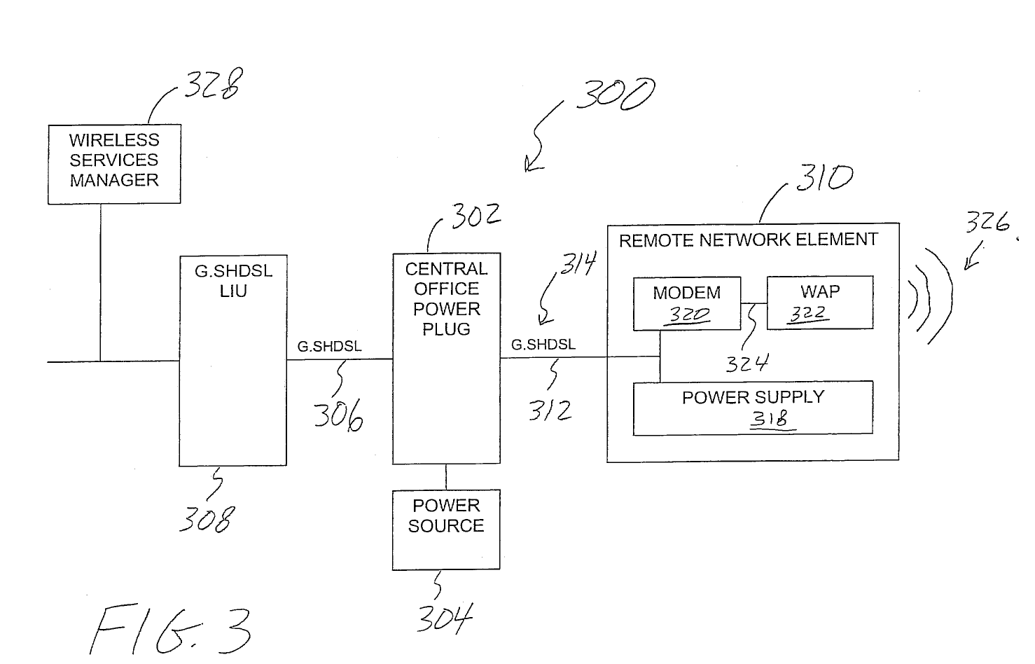

FIG. 3 is a block diagram of one embodiment of a wireless network 300. The embodiment of a wireless network 300 shown in FIG. 3 includes a central office power plug 302 that is coupled to a power source 304. In one embodiment, central office power plug 302 is implemented using an embodiment of the central office terminal 200 described above. An upstream G.SHDSL communication link 306 is provided to the central office power plug 302 over an upstream communication medium (for example, a twisted-pair telephone line). The upstream G.SHDSL communication link 306 couples the central office power plug 302 to a G.SHDSL line interface unit 308. The G.SHDSL line interface unit 308 is coupled to an upstream network (not shown) such as the Internet. In one such embodiment, the G.SHDSL line interface units 308 is inserted into a subscriber access multiplexer (not shown) in order to couple the G.SHDSL line interface unit 308 to the upstream network.

The wireless network 300 also includes a remote network element 310. Remote network element 310 is powered by a twisted-pair telephone line 312 that is coupled between the central office power plug 302 and the remote network element 310. A downstream G.SHDSL communication link 314 is provided over the twisted-pair telephone line 312. The central office power plug 302 supplies power for the remote network element 310 on the twisted-pair telephone line 312 in the same manner as described above in connection with FIG. 2. The remote network element 310 includes a power supply 318 that is coupled to the twisted-pair telephone line 312. The power supply 318 extracts the power supplied on the twisted-pair telephone line 312 by the central office power plug 302. The extracted power is used to power various components of the remote network element 310.

The remote network element 310 also includes a G.SHDSL modem 320 that modulates and demodulates the G.SHDSL signals carried over the twisted-pair telephone line 312. The modem 320 is coupled to a wireless access point 322 over an Ethernet connection 324. The wireless access point 322 transmits traffic to, and receives traffic from various wireless devices (not shown) over a wireless link 326. Examples of wireless devices include computers or personal digital assistants having wireless transceivers. In one embodiment, the wireless access point 322 is a wireless access point that supports the Institute for Electrical and Electronic Engineers (IEEE) 802.11b standard (also referred to as “WI-FI”).

The wireless network 300 also includes a wireless services manager 328 that manages the wireless services provided over the wireless network 300. For example, in one embodiment, wireless services manager 328 manages authentication and other subscriber and service-related information using the Remote Authentication Dial-in User Service (RADIUS) protocol. In one embodiment, the wireless services manager 328 is coupled to the G.SHDSL line interface unit 308 using a local area network connection (for example, an Ethernet connection).

In operation, wireless traffic is received by the wireless access point 322 from various wireless devices. The wireless traffic is transmitted to the central office power plug 302 by the G.SHDSL modem 320 over the twisted-pair telephone line 312. A splitter (not shown in FIG. 3) splits off that portion of the signal used for providing the G.SHDSL communication link and provides it to a communications interface (not shown in FIG. 3) of the central office power plug 302 for appropriate processing. The communications interface transmits the traffic to the G.SHDSL line interface unit 308 over the upstream G.SHDSL communication link 306, where the traffic is processed and forwarded to the upstream network by the line interface unit 308. In the downstream direction, traffic is received by the G.SHDSL line interface unit 308 from the upstream network. The traffic is transmitted to the central office power plug 302 over the upstream communication link 306. The traffic is combined with power from a power supply (not shown in FIG. 3) of the central office power plug 302 by the splitter and the combined signal is transmitted on the twisted-pair telephone line 312. The signal is received by the G.SHDSL modem 320, which forwards the traffic to the wireless access point 322 for transmission to the wireless devices.

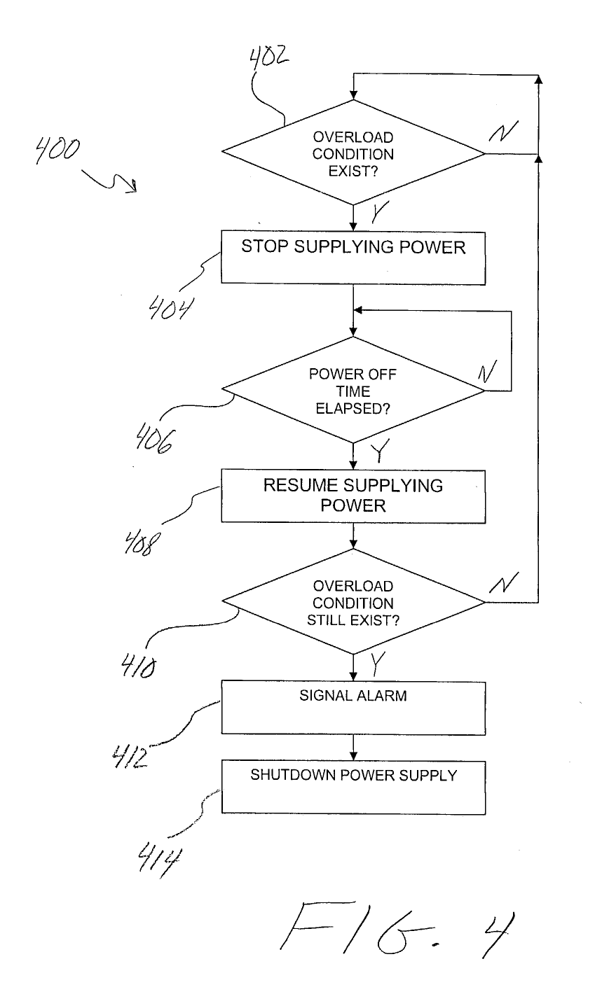

FIG. 4 is flow diagram of one embodiment of a method 400 of responding to an overload condition in a network including line-powered network elements. Embodiments of method 400 are suitable for use with source network elements and sink network elements described here. An embodiment of method 400 implemented using the central office terminal 200 of FIG. 2 is shown in FIG. 4. In one such embodiment, the functionality of method 400 is implemented using an embodiment of controller 212. Other embodiments of method 400 are implemented using other types of source network elements.

Method 400 includes determining if an overload condition exists (block 402). For example, in one embodiment, an overload condition is detected when the overload signal 218 is asserted by the power supply 208. An overload condition may exist for many reasons. An overload condition may exist because of a transient power surge on the twisted-pair telephone line 206 due, for example, lightning. When such a power surge occurs, if the voltage across one of the protection device 211 and 213 exceeds the turn on voltage for that protection device, the protection device will turn on and short the tip line 207 (in the case of protection device 211) or the ring line 208 (in the case of protection device 213) to ground 215. The protection device will remain turned on until the voltage across the protection device drops below the turn on voltage and the current conducted by the protection device drops below the holding current for the protection device.

When such an overload condition exists, the power supply 208 stops supplying power on the twisted-pair telephone line for a predetermined period of time (block 404). The predetermined period of time (also referred to here as the “power off time”) is selected to give the protection devices 211 and 213 enough time to reset and stop shorting the tip and ring lines 207 and 209 to ground 215. The predetermined period of time is also selected so that it is not so long as to cause high priority services (for example, lifeline POTS) to be dropped. Typically, the remote terminal power by such a central office terminal 200 will include some type of power storage device (for example, one or more capacitors) to provide power to the remote terminal while the power supply 208 is not supplying power to the twisted pair telephone line 206. In one embodiment, the predetermined time period is between 50 milliseconds and 100 milliseconds

After the predetermined period of time has elapsed (checked in block 406), the power supply 208 resumes supplying power on the twisted-pair telephone line 206 (block 408). If the overload condition no longer exists after the power supply 208 resumes supplying power (checked in block 410), a full shutdown and reboot of the power supply 208 is not needed. In such a case, if the overload condition was caused by one of the protection device 211 and 213 turning on, having the power supply 208 temporarily stop supplying power on the twisted-pair telephone line 206 is likely to cause the voltage across the protection device to drop below the turn on voltage and to cause the current conducted by the protection device to drop below the holding current for that protection device. By avoiding the full shutdown and reboot of the power supply 208, the chance that a high priority telecommunication services provided over the twisted-pair telephone line 206 will be dropped is reduced. With such an approach, some time may be required for various lower priority data services (for example, DSL) to resynchronize and resume operating properly.

If the overload condition still exists after the power supply 208 resumes supplying power (checked in block 410), an alarm is signaled (block 412). Also, in the embodiment shown in FIG. 4, the power supply is shutdown (block 414). In one embodiment, the power supply 208 will restart when a boot trigger condition exists (for example, the tip and ring lines 207 and 209 are shorted together or timeout period has elapsed). Examples of boot trigger conditions and a power ramp up process for power supply 208 are found in the '593 application.

Although the embodiments of method 400 are described here as sequential steps, this functionality can be implemented in many ways. For example, the functionality can be implemented in analog and/or digital electronic circuitry, or with a programmable processor (for example, a special-purpose processor or a general-purpose process such as a computer), firmware, software, or in combinations of them. In one embodiment, apparatus embodying these techniques include appropriate input and output devices, a programmable processor, and a storage medium tangibly embodying program instructions for execution by the programmable processor. In one embodiment, a process embodying these techniques are performed by a programmable processor executing a program of instructions to perform desired functions by operating on input data and generating appropriate output. In one embodiment, the techniques advantageously are implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the scope of the claimed invention. Accordingly, other embodiments are within the scope of the following claims.

What is claimed is:

1. A method of responding to an overload condition, the method comprising:
supplying power on a communication medium in order to provide power to a network element coupled to the communication medium;
determining if an overload condition exists;
if the overload condition exists, stopping the supply of power on the communication medium for a predetermined period of time;
after the predetermined period of time has elapsed, resuming supplying power on the communication medium; and
if the overload condition still exists after resuming supplying power on the communication medium, signaling a first alarm.

2. The method of claim 1, further comprising if the overload condition still exists after resuming supplying power on the communication medium, shutting down a power supply that is used to supply power on the communication medium.

3. The method of claim 1, wherein stopping the supply of power on the communication medium for the predetermined period of time causes a protection device to reset.

4. The method of claim 3, wherein the communication medium includes at least one twisted-pair telephone lines having a first protection device coupled between a tip line of the twisted-pair telephone line and a ground and second protection device coupled between a ring line of the twisted-pair telephone line and the ground.

5. The method of claim 3, wherein the protection device includes a sidactor.

6. The method of claim 3, wherein the protection device is reset when a voltage across the protection device drops below a turn voltage and a current conducted by the protection device drops below a holding current.

7. The method of claim 3, wherein the predetermined time period is between 50 milliseconds and 100 milliseconds.

8. A network element, comprising:
communication interface that produces a telecommunication service signal that includes traffic for a communication link;
a power interface adapted to couple the network element to a power source, the power interface including a power supply that produces a power signal;
a controller that controls the operation of the power supply; and
a splitter that combines the telecommunication service signal with the power signal and applies the combined signal to the communication medium;
a protection device adapted to be coupled between the communication medium and a ground;
wherein the controller:
causes the power supply to supply power on the communication medium;
determines if an overload condition exists;
if the overload condition exists, causes the power supply to stop supplying power on the communication medium for a predetermined period of time;
after the predetermined period of time has elapsed, cause the power supply to resuming supplying power on the communication medium; and
if the overload condition still exists after the power supply resumes supplying power on the communication medium, signals a first alarm.

9. The network element of claim 8, wherein the controller includes at least one of hardware and software.

10. The network element of claim 8, wherein the controller is included in the power interface.

11. The network element of claim 8, wherein the communications interface couples the network element to an upstream communication medium.

12. The network element of claim 8, wherein a digital subscriber line communication link is provided on the communication medium

13. The network element of claim 8, wherein the network element is a central office terminal.

14. The network element of claim 8, wherein an overload signal is provided by the power supply to the controller, wherein the overload signal is used by the power supply to inform the controller that an overload condition exists.

15. A network element, comprising:
an interface adapted to couple the network element to a communication medium;
a power supply adapted to couple the network element to a power source; and
a protection device adapted to be coupled between the communication medium and a ground;
wherein the power supply supplies power on the communication medium;
wherein the network element determines if an overload condition exists;
wherein if the overload condition exists, the power supply stops supplying power on the communication medium for a predetermined period of time;
wherein after the predetermined period of time has elapsed, the power supply resumes supplying power on the communication medium; and
wherein if the overload condition still exists after the power supply resumes supplying power on the communication medium, the network element signals a first alarm.

16. The network element of claim 15, wherein a first communication link is provided on the communication medium.

17. The network element of claim 16, further comprising a communications interface that couples the network element to an upstream communication link and to the first communication link.

18. The network element of claim 15, wherein the communication medium includes a twisted-pair telephone line.

19. A network, comprising:
a source network element including a power supply coupled to a power source; and
a sink network element coupled to the source network element over a communication medium;
wherein the source network element includes a protection device coupled between the communication medium and a ground;
wherein the power supply supplies power on the communication medium;
wherein the source network element determines if an overload condition exists;
wherein if the overload condition exists, the power supply stops supplying power on the communication medium for a predetermined period of time;
wherein after the predetermined period of time has elapsed, the power supply resumes supplying power on the communication medium; and
wherein if the overload condition still exists after the power supply resumes supplying power on the communication medium, the source network element signals a first alarm.

20. The network of claim 19, wherein the source network element is central office power plug.

21. The network of claim 19, wherein the sink network element is remote network element including a wireless access point.

22. The network of claim 19, further comprising a line interface unit coupled to the source network element.

23. The network of claim 19, further comprising a wireless services manager.
